(19) United States
(12) Patent Application Publication
(10) Pub. No.: US 2016/0137330 A1
(43) Pub. Date: May 19, 2016

(54) DRINKS BOTTLE WITH FEED POSSIBILITY FOR A GASEOUS MEDIUM

(71) Applicant: KRONES AG, Neutraubling (DE)

(72) Inventor: BERND SOBIECH, Regensburg (DE)

(73) Assignee: KRONES AG, Neutraubling (DE)

(21) Appl. No.: 14/896,275

(22) PCT Filed: Jun. 4, 2014
(86) PCT No.: PCT/EP2014/061539

§ 371 Date: Dec. 4, 2015

(30) Foreign Application Priority Data
Jun. 4, 2013 (DE) 10 2013 105 760.8

(51) Int. Cl. B65D 1/02; B29D 22/00

(52) U.S. Cl. CPC B65D 1/023; B29D 22/003; B29K 2105/258

(57) ABSTRACT

Container to receive liquids, comprising a main body which surrounds a receiving volume to receive the liquid, and a mouth section for delivery and/or withdrawal of the liquid, wherein this mouth section has a first opening via which the liquid can be withdrawn from the container. According to the invention at least one second opening is provided in the mouth section and by means of said opening a gaseous medium can be delivered to the container at least intermittently, wherein the planes in which the first opening and the second opening are disposed differ from one another.

The present invention relates to a drinks bottle as well as a closure for a drinks bottle. In addition, the invention relates to a method for removal of liquids from drinks bottles and also to a method of production of such a drinks bottle.

So-called large containers or bulk packs, which are used for example in catering establishments or tap systems, have been known for a long time from the prior art. Containers for use in these tap systems (so-called disposable kegs or party kegs having a capacity of between 5 litres and 50 litres or for use in dispensers (usually in the form of PET bottles holding up to 5 litres) are for example stretch blow moulded from plastic parisons, filled and closed.

In this case it is also known from the internal prior art of the applicant that the containers are first of all closed and only then are filled. In these cases the filling takes place through the closure. Furthermore, containers are also known which are used a number of times in a multiple-use process. In addition, metal containers are usually used in the prior art.

The containers are usually provided with closures having a valve function with so-called fittings. These fittings have a liquid valve which serves for dispensing liquid and/or for filling of the container. In addition, these closures sometimes also have a gas valve through which, in the case of filling through the closure, it is possible to perform filling functions such as for example pressurising, inert gas flushing or pressure relief. In addition, a pressure medium for assisting the dispensing of the liquid contained in the container can also be delivered through these valves. Likewise, a relief of pressure can be carried out through these valves after a container emptying operation, for example a tapping operation.

In the prior art such valve functions are always disposed inside the container mouth, since a fluid communication has to be produced between a drink dispensing pipe and the interior of the container. The generally cylindrical neck region of the container has a mouth rim for sealing relative to a cover surface of the closure as well as for example externally located latching elements, in order to be able to fix the closure to a neck region of the container. In addition, the container often has one or more carrying rings on which the container can be handled or transported in a filling plant. In addition, internal or external threads can also be provided in order to fix a closure on the container.

Since these valves or valve functions of the fitting are disposed inside the mouth, the neck region usually has a correspondingly large diameter up to 60 mm and more. Accordingly, in this neck region a very large amount of material, that is to say in particular PET, is wasted. Accordingly, the fittings also have a large diameter associated with further material costs.

Therefore the object of the present invention is in particular to reduce the material consumption in the production of such containers or container closures. This object is achieved by the subjects of the independent claims.

Advantageous embodiments and modifications are the subject of the subordinate claims.

A container closure according to the invention for liquid containers has a receiving region in order to receive a mouth portion of the liquid container. Furthermore, the container closure has a fastening means in order to lock the container closure on the container, and also a covering means in order to completely cover a mouth opening of the liquid container. In this case, in a state in which the container closure is locked on the container, a first opening, via which a first liquid can be removed from and/or delivered to the liquid container, can be introduced into this covering means, wherein this opening is located at least partially inside the cross-section of the mouth of the liquid container.

According to the invention the container closure (in particular in a state in which it is disposed on the container or on this mouth) has a predetermined opening section which lies outside the mouth or the mouth cross-section of the container and by means of which a (second) flow connection can be produced with the internal volume of the liquid container on which the container closure is locked. Also by means of this second flow connection a fluid, that is to say in particular a liquid or preferably a gas, can be conveyed between the interior of the container and the surroundings.

It is therefore proposed that the container closure itself has two predetermined opening points, by means of which two flow paths preferably (at least partially) separated from one another can be produced with the container. In this case, as mentioned above, one of these openings is located inside the mouth cross-section of the container and the other is located outside the mouth cross-section. Advantageously the said second opening is located in a radial direction with respect to a longitudinal direction of the container outside the said mouth cross-section. In this way it is possible to let the mouth cross-section of the container be relatively small, since the delivery of a second medium, for example carbon dioxide, is carried out via an opening which is located outside the mouth cross-portion of the container. In an advantageous embodiment the container closure is produced from a plastic. Thus it is possible that this container closure has predetermined opening points, for example thinned areas of the material, valve devices or the like, in the region in which the openings are to be located.

In a further advantageous embodiment the first opening is located completely inside the cross-section of the mouth. A liquid is advantageously removed from the container via this first opening. However, it would also be possible for a gas to be delivered to the container via the first opening, for example for pressurising.

In particular a description is given below of the alternative in which gas is delivered or drawn off outside a mouth region gas and liquid is removed or delivered inside the mouth diameter. However, the invention can also be applied conversely in such a way that the liquid is removed through the opening disposed laterally adjacent to the mouth cross-section and thus preferably also through a lateral opening in the neck region of the container and thus correspondingly liquid is delivered or drawn off on the outside of the neck region of the container and conversely the gas is delivered and or drawn off inside the mouth diameter or the mouth cross-section. Therefore both openings preferably serve for a fluid communication, which in this case may involve both a liquid and also a gas. Advantageously, however, one opening serves for gas communication and the other opening serves for liquid communication.

Because only one valve, in particular the liquid valve on which for example a riser pipe can also be disposed, is disposed inside the mouth cross-section, the neck region can have a substantially smaller diameter, for example in the region of 28 mm. This leads to considerably lower material consumption. Further material savings can be made due to the cutaway area of the gas outlet holes (in the container) which can be located for example in the mouth region. The invention can advantageously be used for plastic disposable kegs without a liner. However, it can also be used in containers made of other materials, such as for example plastics, metals and the like, wherein the containers or closures can also have so-called liners. In addition, however, the invention could also be used in reusable containers.

The liquid can advantageously be removed from the container without compression of the container itself. In a further advantageous embodiment the container closure has a pipe which adjoins at least one opening and can extend into the interior of the container. This pipe is advantageously disposed adjoining the first opening or the first predetermined opening point which is located inside the mouth cross-section. In this case it is possible for such a pipe, also designated below as a riser pipe, to extend as far as the base of the container. In this way the container can be emptied substantially completely even when it is not compressed. In this case it is possible for this pipe to be configured to be flexible, for example as a flexible hose which adjoins the respective opening.

In a further advantageous embodiment the locking means has an engaging device which engages behind a part of the container for locking of the container closure. In this case for example the locking means can engage behind a carrying ring of the container. Likewise it is possible to engage in a groove on the container instead of the carrying ring. As a result further material savings can be made.

Advantageously the container closure has a circumferential wall which, in a state in which the container closure is locked on the container, is configured to completely encircle the mouth of the container. In a further advantageous embodiment the locking means is also configured to be encircling. However, it would also be possible for the locking means to co-operate with an external thread of the container in order to dispose the container closure on the container.

In a further advantageous embodiment the second predetermined opening section is spaced apart from the first opening. In this case, as mentioned above, it is possible for both the first opening (or a first predetermined opening section) and also the second predetermined opening section to be disposed in the said covering means. Advantageously these opening sections do not merge into one another but are separated from one another by a material section. In this way it is possible for one opening to be located completely outside the mouth of the container and for the other opening to be completely inside the mouth.

In a further advantageous embodiment the covering means is configured as a cover surface projecting beyond the mouth of the liquid container.

In this case the second predetermined opening section is preferably formed in this cover surface and in particular in the section of the cover surface which projects beyond the mouth rim. In this case it is possible for this cover surface to be circular for example and thus to project symmetrically beyond the mouth rim. However, it would also be possible for the cover surface to project beyond the mouth rim in the circumferential direction of the mouth only in one region, and for the second predetermined opening section to be disposed in this region.

The cover surface advantageously has a material which can be pierced or cut through at least in one region. This means that in this region an opening can be produced without the cover surface being deformed in such a way that the sealing effect is also nullified.

In a further advantageous embodiment the container closure has a first sealing means in order to seal the covering means relative to the mouth rim. Furthermore, for example the mouth region of the container can have a sealing region on which a fluid-tight seal can be produced between the container closure and the mouth region.

A connection between the mouth section and the mouth of the container can take place for example by welding, glueing or also arrangement of a sealing element such as an O ring. A hollow space for the passage of gas is formed by this seal or the sealing means. Thus the sealing region does not involve the usual sealing between the mouth rim and a closure. This sealing region is advantageously formed between the mouth of the container and the closure in such a way that by it the two flow connections between the container and the surroundings of the container, which are mentioned above, are completely separated from one another.

Thus it is also possible that the container closure has a receiving region to receive the mouth section of the container, and one of the said openings is located within this receiving region and the other is located in particular in the radial direction outside this receiving region. A liquid dispensing region is preferably disposed in a covering wall of the container closure, and is particularly preferably disposed centrally. In this case a liquid valve can be provided which is optionally and preferably adjoined by the above-mentioned riser pipe.

As mentioned, this riser pipe can be flexible or rigid and preferably, in the installation position, extends as far as the base of the container. As mentioned, this riser pipe serves on the one hand for the withdrawal of liquid, but on the other hand it can also serve for filling of the container. The covering wall or the covering means does not necessarily have to have a liquid valve. It is likewise possible for the covering means to have a puncture region for a piercing fitting on which a liquid dispensing pipe (in particular in the form of a tap pipe) is disposed, wherein in this case the puncture region is advantageously located inside a cross-section of a riser pipe.

The region for dispensing liquid is advantageously somewhat smaller in diameter than the internal diameter of the mouth of the container or the internal diameter of the mouth is adapted to the space required for the liquid dispensing system. In the installation position the covering means or the covering wall can at least partially form a seal with the mouth rim of the container and lie in contact thereon. This leads, where applicable, to a higher stability of the arrangement consisting of the container and the closure locked thereon.

As mentioned, the second opening is preferably disposed in the covering means or the covering region. However, alternatively or additionally, it would also be possible to dispose the second opening in a side wall or circumferential wall of the container closure. The cross-section of the container closure is preferably chosen to be greater than a mouth cross-section of the liquid container in such a way that, with the container closure fitted or locked onto the liquid container, a channel and in particular a gas channel is formed which encircles the mouth of the container at least partially and preferably completely.

As mentioned above, the container closure preferably has at least one valve device. In this case, however, a valve device for the delivery and discharge of liquid can also be provided for a corresponding delivery or discharge of gas. In a further advantageous embodiment at least one such valve device is associated with the predetermined opening section and/or there is a flow connection thereto.

Thus one of these valve devices and in particular the valve device disposed outside the mouth rim of the container may be a gas valve. This gas valve can open into a hollow space between the closure side wall and the mouth region of the container, and this gas valve can also be disposed inside the said hollow space. This gas valve can preferably produce a fluid communication between the outer surroundings of the closure (which may also be understood as a gas supply and discharge pipe) and a hollow space between the closure side wall and the mouth region of the container. Also the gas supply and/or discharge region may be distinguished in such a way that no valve is used but a puncture region for a piercing fitting is provided.

The above-mentioned circumferential wall or side wall of the container closure is not necessarily configured to be cylindrical or with a circular cross-section. It may be sufficient that the side wall has a shaping, on which in particular the above-mentioned gas valve is disposed and which forms the said hollow space. In this case the above-mentioned gas channel does not surround the container closure on the compete circumference, but only in a region of the circumference and is in particular disposed laterally beside the mouth rim of the container.

In this case it is possible for corresponding gas passage openings in the mouth region of the container also to be aligned in this said hollow space. In this embodiment the container and/or the closure preferably have alignment elements. In this case, such alignment elements can function purely mechanically, in particular when the container closure is disposed on the container, or can also be detected in a filling plant for example by sensors, wherein the alignment then takes place through the respective handling elements of the filling plant.

Advantageously the above-mentioned sealing section of the closure or the sealing region in terms of its shape to the sealing region of a mouth region of the container. Advantageously both are circular. However, it would also be possible for an alignment function to be produced by this sealing region itself if the closure side wall is not cylindrical and has a shaping for a valve, in particular a gas valve. The said sealing region is located in the closure/container arrangement preferably below the gas passage openings, wherein “below” should be understood with reference to an upright container in which the mouth is directed upwards.

Advantageously the hollow space outside the neck region is at least so great that an arrangement for the passage of compressed gas through the closure has sufficient space to function.

The positioning and/or shape of the hollow space to be formed outside the neck region as well as the type and positioning of the liquid and gas transfer regions through the closure wall is also possible in various other combinations and variants.

As mentioned, the invention can also be used with containers which have a so-called liner. This can for example be co-extruded or can be introduced into the prepared container at a later stage. Advantageously the said liner is only introduced after production of the gas passage openings, so that the liner is not damaged in this method step. The liner is preferably attached to the neck region above the gas passage openings. Particularly preferably it is glued or welded to the neck region. Such a liner can also be clamped by the closure/container arrangement between the mouth rim and the closure. Likewise it is possible for the liner to be introduced into the container with the container closure and, where applicable, for the riser pipe to be disposed thereon. In this case the liner can also already be fastened to the closure and/or to the riser pipe and/or to the valve.

When a liner is used it is advantageous that the drink cannot enter through the gas outlet openings into the above-mentioned hollow space between the mouth of the container and the closure side wall. Then the arrangement or positioning of the gas passage openings in the container is no longer so significant. The flexibility with regard to the pressure medium in the emptying process is also advantageous. It is not necessary here to use product gas, for example CO₂ in this case, but also simple compressed air or even a liquid medium can be used.

The withdrawal of liquids can take place in the case of an upright container as well as in the case of an inverted container (in which the neck region extends downwards). In this case a different arrangement of the fluid passage opening may be preferred.

Furthermore, the present invention is directed to a liquid container with a container closure of the type designated above which is or can be locked thereon. In this case, in a state in which it is closed by the container closure, the liquid container has an opening by means of which a flow connection and in particular a gas connection of the liquid container is or can be established with a space formed between the liquid container and the container closure.

Ideally such a hollow space is provided outside an external circumference of the container in the mouth region thereof. In this case, as is described in greater detail below, the liquid container can preferably have a plurality of openings in the mouth region. In a further advantageous embodiment the container also has a carrying ring or a groove behind which a section of the container closure can engage.

Furthermore, the present invention is directed to a method of withdrawal of liquid from a liquid container, wherein a container closure is locked on a mouth of this liquid container and the liquid is withdrawn with the closure locked on the liquid container. According to the invention a first opening is introduced into the container closure in order to enable a first fluid connection and in particular a liquid connection for the withdrawal of the liquid from the liquid container. Furthermore, a second opening is introduced into the container closure in order to provide a second fluid connection and in particular a gas connection between the interior of the liquid container and the surroundings of the liquid container.

In this case one opening, preferably the first opening, is located inside the mouth cross-section of the container and the other opening is located outside the mouth cross-section of the container. Advantageously the first opening, by means of which liquid is delivered or discharged, is located inside the mouth cross-section of the container, and the second opening, which in particular is located outside the mouth rim of the container, serves for a gas exchange, in particular for delivery of a gas.

The two openings are advantageously introduced in such a way that they are completely separated from one another. In a further advantageous embodiment the container preferably has a further opening in addition to its mouth opening.

In a further advantageous method the liquid is withdrawn without squashing or compression of the container.

In a further advantageous embodiment the liquid is withdrawn by means of a pipe which in particular adjoins the container closure. This pipe advantageously protrudes into the liquid located inside the container, and particularly preferably this pipe extends as far as the base of the liquid container. The method advantageously comprises the following steps:
provision of a liquid-filled container
arrangement of the container in a withdrawal location
connection of the closure to a suitable withdrawal fitting
withdrawal of liquid from the container by application of a pressure medium to the interior of the container (wherein the interior may also be an intermediate space between the container wall and a liner)
passage of pressure medium through media passage openings which are preferably disposed in a neck region of the container or
transfer of gas out of a hollow space disposed on the outside of the neck.

It is pointed out that the sequence of the above-mentioned steps is not binding and some of them can also be carried out simultaneously. Some of the said steps are also referred to as alternatives, so that not all of the said steps have to be carried out. Preferably, however, the gas passage opening is not a usual mouth opening of the container. During the withdrawal of liquid, compressed gas is introduced into a hollow space between the closure and the neck region of the container.

The present invention further relates to a container and in particular a plastic container and particularly preferably a plastic container made of PET to receive liquids. This plastic container has a main body which surrounds a receiving volume to receive the liquid. Furthermore, the container has a mouth section for delivery and/or withdrawal of the liquid, wherein this mouth section has a first opening via which liquid can be withdrawn from the container.

According to the invention at least one second opening is provided in the mouth section and by means of said opening a gaseous medium can be delivered to the container at least intermittently, wherein the planes in to which the first opening and the second opening are disposed differ from one another.

Furthermore, therefore, a container is proposed which can be used in particular in connection with the above-mentioned container closure and which, in contrast to containers which are known from the prior art, has at least one further opening in addition to the mouth opening. By means of this further opening a gas can be delivered to the container for example for withdrawal of the liquid. Conversely, however, it would also be possible to deliver the gas via the usual mouth opening and to deliver the liquid for example via the further opening.

The container is advantageously a container which is formed in one piece. It is advantageously also a single-walled container.

Thus a neck region of the container preferably has a mouth opening. The container can be filled or emptied via this mouth opening. For this purpose for example parts of the above-mentioned closure or fitting can protrude into this mouth opening into the interior of the container. The first opening or the mouth opening preferably has a mouth rim which for reasons of stability can particularly preferably bear against the closure at a receiving region of the closure for the mouth rim. With this receiving region for the mouth rim the container closure can bear only against the mouth rim and in this case can preferably be completely or partially sealed.

Furthermore, this mouth rim advantageously defines the side on which gas or liquid is delivered and/or discharged.

Thus, as mentioned above, a container is also proposed, in particular for use in a drinks dispensing device such as a tap system, wherein the neck region has at least one additional (gas) passage opening. Through this gas passage opening described above the gas transfer can take place from the interior of the container to the exterior and vice versa. Thus the diameter of the neck region can be decreased at least partially relative to conventional diameters, since the gas is no longer withdrawn or delivered inside the mouth diameter, but outside.

The gas passage openings serve for the passage of gas in at least the following process steps: inlet of gas into the interior of the container and/or outlet of gas therefrom, when filling takes place through the closure or the fitting (for example inert gas flushing, pre-tensioning, pressure relief, where applicable inert gas flushing and sterilising), for a fluid inlet for a tapped fluid when drinks are dispensed; where applicable for a fluid outlet in the event of a pressure relief of an emptied container, which in particular serves for safety.

In the upright state the container advantageously has a sealing region which is particularly preferably located at least below the openings. A container closure can advantageously bear in a fluid-tight manner against this sealing region, for example a carrying ring or an extra ring provided for sealing. Between this ring and a mouth rim, a hollow space can for example be formed between the neck region and a closure side wall or between a sealing region and a closure cover wall. In this region, and preferably also in the covering wall of the closure, a gas dispensing region can be provided and in particular a gas valve can be disposed, which particularly preferably can also be actuated from the exterior.

In a further advantageous embodiment the mouth region has a circumferential wall surrounding the first opening and the second opening is disposed in this circumferential wall. In this embodiment the openings are preferably separated completely from one another. However, it would also be possible that the openings in the circumferential wall also protrude into a region of the mouth rim and therefore a separation of the openings is only effected by the fitting or latching of the container closure. Thus for example recesses could for example be provided in the circumferential edge of the mouth. If a sealing region is now placed on this circumferential edge, at the same time a separation into a mouth opening and into the openings of the circumferential wall is achieved by this region.

In a further advantageous embodiment a plurality of openings are provided which are spaced apart from one another. In particular the said second openings are spaced apart from one another in the circumferential direction of the mouth section. In this way a further saving of material can be achieved.

In a further advantageous embodiment the first plane and the second plane are substantially perpendicular and in particular perpendicular to one another. In this case it may in particular be provided that the circumferential wall which surrounds the first opening is of cylindrical construction. In a further advantageous embodiment an encircling ring which extends at least in a radial direction of the container is disposed on the mouth section. This ring advantageously extends substantially precisely in a radial direction and in particular also perpendicular to a longitudinal direction of the container. This ring may be a carrying ring of the container by means of which the container can for example be transported. In this case, however, this carrying ring can also serve for sealing relative to the container closure.

In a further advantageous embodiment at least one second opening has a circular or a slot-shaped cross-section. Such openings are easy to introduce during production.

In general one or more openings and in particular gas passage openings can be disposed in the neck region. If only one gas passage opening is provided, a hollow space which is adjacent to this opening and is formed between the container closure and the mouth is advantageously also aligned with this gas passage opening. The above-mentioned circular holes can be relatively easily drilled, milled, punched or also pierced or even melted with the aid of a hot needle. A slit-like opening in turn is well suited for vibration cutting. However, it would also be possible for the openings to be oval or some other shape. It would also be possible to configure the opening in the form of a certain character, for example a company logo, so that in this way the opening also serves as an indication of the manufacturer.

In this case it would be conceivable that the said second openings are already arranged at the time of production of the container or production of the associated plastic parisons, for example when the plastic is still in a plastically deformable state. In particular the openings can be disposed in the aforementioned neck region. It would also be possible to produce these openings on an already produced or finished plastic parison. In addition and preferably it is also possible to produce the (gas) passage openings on a finished container, since then the conventional stretch blow moulding process is no longer negatively influenced. Alternatively it would also be conceivable that the gas passage openings are additionally sealed during a stretch blow moulding process so that in this way the blowing fluid does not escape. This can also take place advantageously with a stretch blow moulding machine which during the stretch blow moulding process seals the blow moulding die on a carrying ring of a container or on the stretch blow mould.

In a further advantageous embodiment the openings are disposed obliquely, in particular obliquely from the exterior inwards with respect to the mouth wall. Thus it may be preferable that the openings are disposed in such a way that product fractions which slop through the (gas) passage openings during transport can flow back again into the interior of the container. In this way a residual emptying of the drink can be assisted. As mentioned above, the said openings are preferably disposed above a neck region of the container on which the container closure closes in a fluid-tight manner with the neck region (also designated below as the sealing region) and by which the (gas) passage space is formed.

Furthermore, the present invention is directed to a method for production of a plastic container and in particular a plastic container of the type described above, wherein a plastic parison is provided which is subsequently transformed by a blow moulding operation to produce a plastic container. According to the invention at least one second opening is formed during or after the production of the plastic parison. The plastic container is advantageously produced by a stretch blow moulding process.

In a further advantageous method at least one second opening is produced after the transforming process. In this way, as mentioned above, it is possible to prevent the second openings from impeding the expansion process, which takes place in particular with blowing pressure.

In a further advantageous method at least one second opening is produced by a mechanical operation. This mechanical operation is selected from a group of operations including drilling, milling, cutting, punching, melting, combinations thereof and the like.

In a further advantageous embodiment at least one second opening is disposed above the above-mentioned ring. In this case “above” should be understood to mean that the second opening is disposed nearer to the first opening in the longitudinal direction of the container than the said ring.

In a further advantageous embodiment the at least one second opening is disposed nearer to the ring than to the first opening. In this way on the one hand a valve device can be more easily accommodated in a closure and on the other hand the flow conditions, in particular for the delivery of a gas to the interior of the container, can also be made easier and thus in particular a more favourable flow can be achieved.

Thus the mouth region of the container preferably has a connection region at which the container closure is connected or can be connected to the mouth region. This connection region can also have an internal thread and/or an external thread. In particular when an external thread is used an engagement region can additionally be provided for a quality feature, such as for example a “tamper evidence ring”. Alternatively or additionally it would also be possible for another type of safeguard against misuse to be provided.

As an alternative or in addition the connection region can also be a latching point or can have a latching point, at which latching point the closure latches in place in the neck region of the container. In this case such a latching point can be provided on a mouth region or on the aforementioned carrying ring. The arrangement of a closure on the neck region is influenced by the aforementioned connection region in such a way that sealing can actually also take place on a sealing region.

Where applicable, the neck region can also have a carrying region, such as for example a carrying ring. The container is for example handled, gripped and/or transported using this carrying ring. Likewise a handle can be held on this carrying ring. However, it would also be possible for the container to be held in some other way, for example upright or on its body or main body.

In addition it is also possible that the aforementioned sealing regions, carrying regions and connection regions in each case also take on several of the said functions. Thus—only referred to by way of example—the carrying region can also serve as sealing region. Thus for example the container can be supported by means of the underneath face of the carrying ring and thus can be carried and sealed by means of an upper face of the carrying ring. In addition it would also be possible for the closure to be welded or glued on a carrying ring or for the carrying region to serve as connection region, wherein for example the closure, as shown in greater detail below, can latch in place on an underneath face of the carrying ring.

In a further advantageous configuration it would also be possible that the diameter of the neck region is not reduced completely, but only partially. Thus for example the upper part of the container mouth could be reduced in diameter and could have the (gas) passage openings. An external thread with a sealing ring located above it (which functions as a sealing region) could be disposed for example below the (gas) passage openings, wherein the thread could then have a conventional diameter. A carrying ring with a conventional diameter could then be disposed below the thread, so that as far as possible conventional container handling can be used in the filling plant. When the neck diameter is reduced, unstable transport could otherwise occur, so that additional guide fittings can or must be used for the container.

If a thread is used for fastening of the closure, the aforementioned second openings and in particular gas passage openings are preferably located below an internal and/or external thread of the neck region on which the closure is screwed. Alternatively it would also be conceivable for the gas passage openings or the second openings to be located above an external thread, but then the thread preferably forms a fluid-tight seal directly below the second openings. For this purpose an additional sealing element could also be disposed there.

Alternatively it would also be conceivable for the second openings also to be disposed inside the thread or the thread pitch turns. Then it would be conceivable that openings and in particular (gas) passage channels are possibly disposed in the thread itself. A gas could then be conveyed to or from a gas passage space via these openings. However, this could possibly make residual emptying more difficult.

In addition, as mentioned above, it would also be conceivable for the second openings to be formed by notches or the like in the mouth rim. Also in this case residual emptying can be difficult. In this embodiment it is advantageous if these notches are configured as slots, in particular as slots extending as far as the sealing region, between the closure and a carrying ring.

In a further advantageous embodiment a further ring could be provided which can also be used as a carrying ring and which also serves as a sealing region for the container closure. The said second openings are then preferably disposed above this upper ring.

Thus a plastic parison or a container and in particular a container for dispensing drinks is proposed, which has openings and in particular gas passage openings in particular in its neck region, so that the gas can be extracted or delivered on an outer face of the neck region.

Also the method of production of the described container can comprise the following steps, wherein here too the sequence of these steps is not binding and some of the steps can also be carried out simultaneously. Furthermore, some of the following steps are also referred to as alternatives, so that an appropriate selection can be made.

Thus in one method step a plastically deformable workpiece is produced or a plastic parison is produced or is also provided. In a further method step a container is produced from the plastic parison or also, as mentioned above, alternatively the container is produced from the plastic parison with sealing of gas passage openings. Furthermore, gas passage openings are then produced. In a further method step this container can be transported, wherein in particular it is also conceivable for a container with gas passage openings to be transported.

In addition further method steps are provided which relate in particular to the further handling, filling and closing. Thus for example first of all a container is made available and, where applicable, is also transported. Then the (gas) passage openings can be produced. Furthermore, in one method step material residues produced during the production of the (gas) passage openings can be removed. In a further step the container can be filled, wherein medium or gas preferably also passes through the (gas) passage openings in the neck region of the container. This can simplify the filling operation, since filling can take place completely via the mouth and nevertheless the air located in the container can escape.

In a further method step additional handling of the container is also possible, such as for example sterilisation of the inner region, the outer region, in particular the outer neck region thereof, inert gas flushing, pre-tensioning or pressure relief. Furthermore, the container can be closed in particular by the above-mentioned container closure.

Depending upon the embodiment of the fluid passage openings it may advantageously be necessary that sealing of the filling valve takes place for example on the carrying ring, for example also through a movable press-on cover.

Furthermore, a filling process may also be configured in such a way that a process gas flows through a hollow space between a container closure and the container neck.

Further advantages and embodiments are apparent from the appended drawings.

In the drawings:

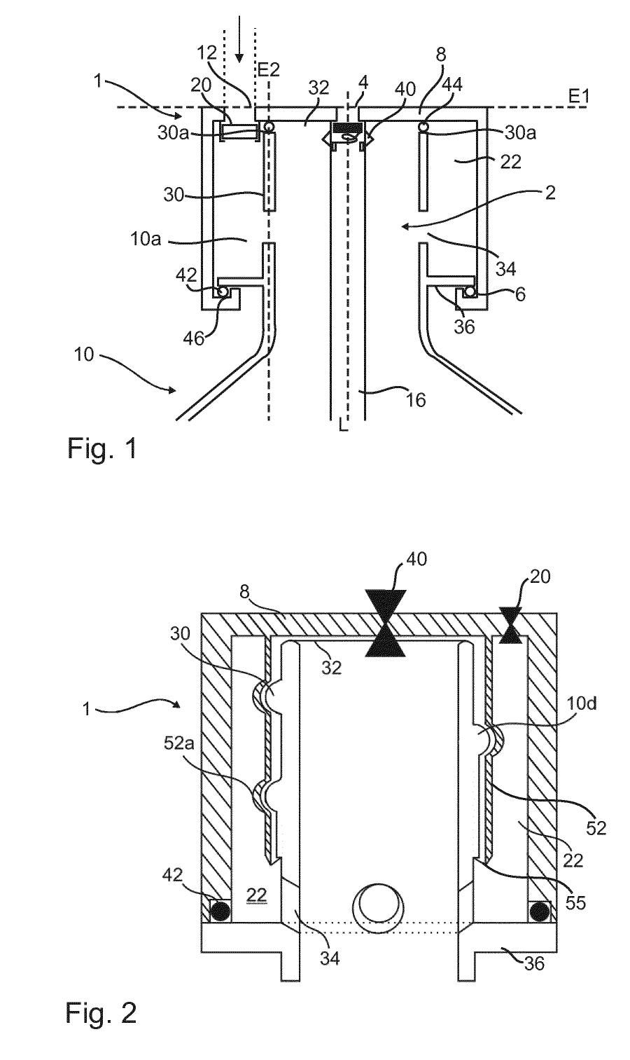

FIG. 1 shows a representation of a mouth section of a container with a closure disposed thereon;

FIG. 2 shows a container mouth with closure in a second embodiment;

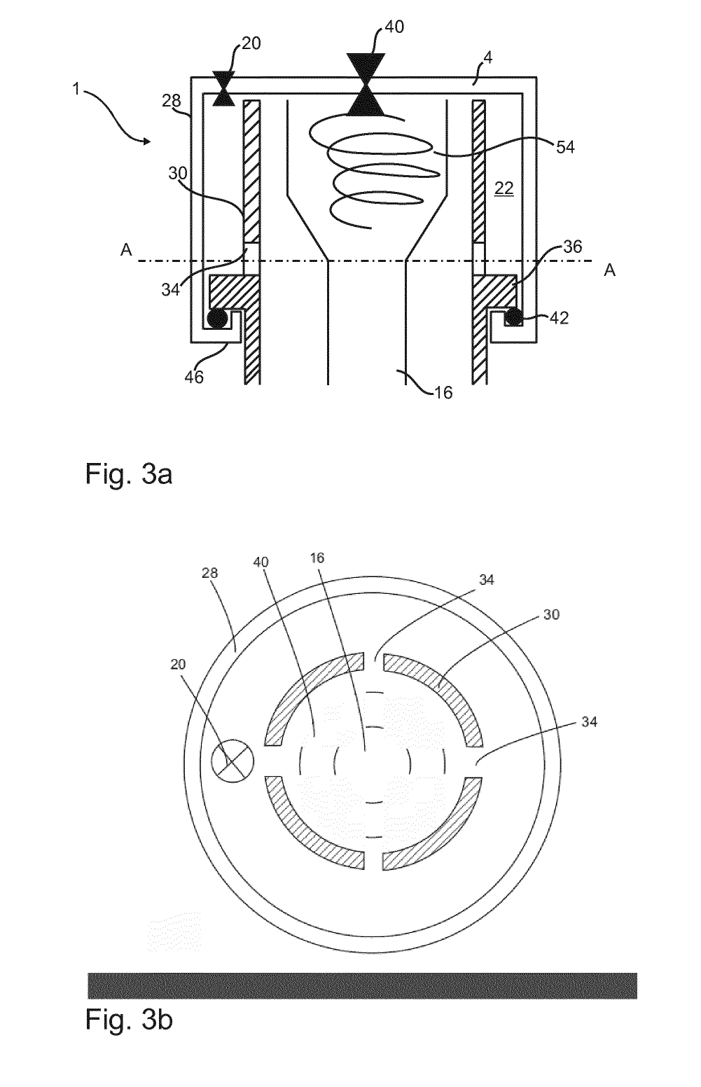

FIGS. 3a and 3b show two representations of a further embodiment of a container mouth with a closure disposed thereon;

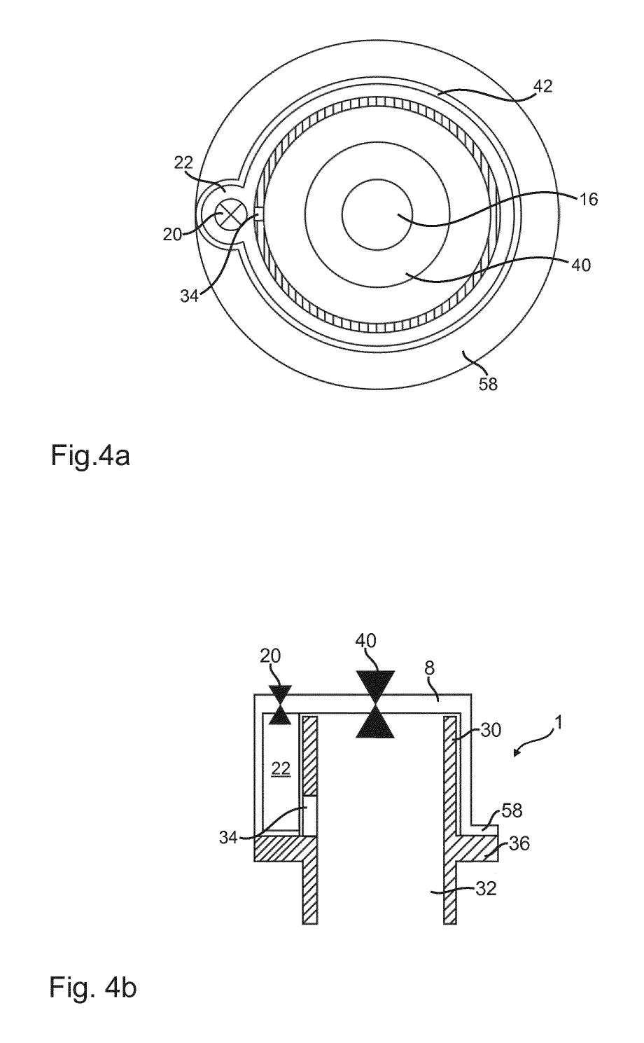

FIG. 4a shows a further configuration of a container according to the invention with a carrier closure disposed thereon; and

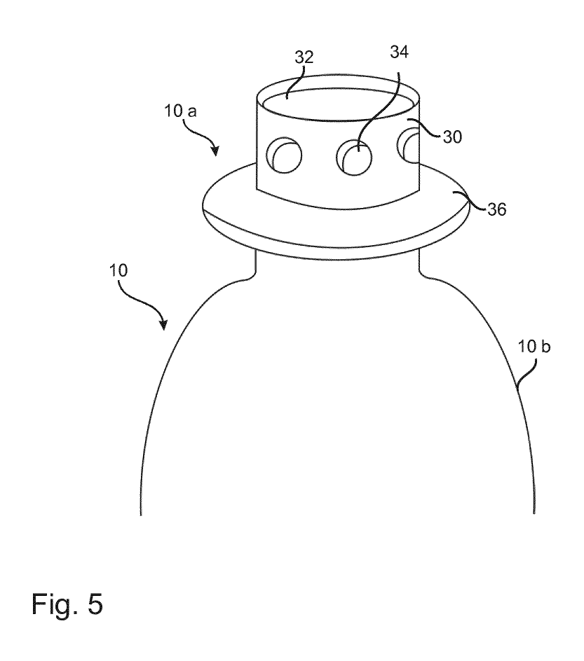

FIG. 5 shows a representation of a mouth region of a container according to the invention.

FIG. 1 shows a representation of a container 10 on which a container closure 1 is disposed. In this case the container 10 has a main body, which extends below the drawing here, as well as a mouth section 10a on which the closure 1 is also disposed. Furthermore, the container 10 has an annular section 36, such as in particular a carrying ring, which also serves here for securing of the container closure 1. For this purpose the container closure 1 has an engaging section 46 which protrudes inwards radially with respect to the carrying ring 36 and a longitudinal axis L of the container and thus enables securing of the container closure 1. Furthermore, the plastic container 10 has a mouth or opening 32 in the mouth region 10a, as is usual in the prior art. In addition, however, the container 10 also has second openings 34 which here are disposed in a circumferential wall 30.

The container closure 1 here has a fastening means designated as a whole by 6 in order to fasten the container closure 1 on the mouth section 10a. In this case, as mentioned above, this fastening means engages behind the carrying ring 36.

The reference numeral 8 designates a covering means which, when the container closure is applied to the mouth 10a, closes the mouth 32 substantially completely. The reference numeral 44 designates a first sealing means, which can be formed here for example as an O ring which can be pressed onto the mouth rim 30a of the mouth 10a.

The reference numeral 4 designates a first opening which can be introduced into the covering means. Liquid can be withdrawn from the container via this opening 4. A valve 40, by means of which the inflow or outflow of liquid out of or into the container, can be controlled can adjoin this opening 4. In particular this valve 40 can be opened by a withdrawal fitting such as for example a tap head.

The reference numeral 12 designates a desired opening section in which a further opening can be introduced into the container closure 1. It will be recognised that this desired opening section 12 is located outside a region of the container defined by the mouth 32 or the edge thereof. A hollow space 22 which in this case surrounds the mouth region 10a of the container 10 adjoins this desired opening section 12.

The reference numeral E1 designates a first plane in which the opening 32 is disposed. The reference numeral E2 designates a second plane in which the second opening is disposed.

It will be recognised that these two planes E1 and E2 are not parallel to one another and in this case are in particular perpendicular to one another.

The reference numeral 20 designates a second valve device which is associated with the desired opening section 12 or with the opening formed hereby. In this way entry of gas to the container or withdrawal of gas therefrom can be controlled.

The reference numeral 16 designates a pipe section which adjoins the opening 4 or the valve 40. As mentioned above, in this case this pipe section can protrude into the container and in particular can serve for complete emptying thereof.

FIG. 2 shows a further embodiment of a container closure 1 according to the invention. Likewise in this embodiment the two valve elements 20 and 40 are again provided. However, in contrast to the embodiment shown in FIG. 1, in this case the closure 1 is fastened by means of a thread 52 to a circumferential wall 30 of the mouth. For this purpose the container has an external thread 10d which co-operates accordingly with sections 52a which are disposed on a container closure. Accordingly the reference numeral 10d designates a threaded section which serves here for securing the container closure. In addition an engaging section 55 can also be provided which can engage on a region of the container mouth. Furthermore, here too the first and second openings 32, 34 are again shown, wherein here again a gaseous medium can be introduced into the container or removed therefrom via the opening 34.

The reference numeral 42 in turn designates a sealing means which provides for sealing of the hollow space 22 surrounding the container mouth. Thus the carrying ring 36 also serves here as a sealing region. It will be recognised that the (gas) passage openings 34 are disposed obliquely and in particular slope inwards, so that, as mentioned above, liquid medium entering the hollow space 22 flows back again into the container. However, instead of the illustrated O ring 42 glueing or welding of the closure on the carrying ring 36 would also be possible in order thus to effect the sealing. Furthermore, the reference numeral 55 or the engaging device can also serve as quality assurance, that is to say as proof of whether a container has already been opened. This can be implemented in such a way that a predetermined breaking region is provided which breaks when the closure 1 is unscrewed from the container for the first time and thus makes it possible to detect opening. Advantageously this quality assurance feature can also be disposed in such a way, for example on a circumferential wall of the container closure, that it can engage behind the carrying ring and as a result constitutes a quality seal which is visible from the exterior.

FIGS. 3a and 3b show a further embodiment of a device according to the invention. Here too the two valves 20 and 40 are again provided, wherein in this embodiment a widening body by means of which the delivery of liquid into the container is simplified adjoins the valve 40. In this embodiment the closure 1 is in turn locked on the carrying ring 36 of the container by engaging behind it. In addition, here too a riser pipe 16 is again provided as well as the encircling hollow space 22 by means of which the gas connection is produced via the gas valve 20. FIG. 3b shows a plan view along the line A-A shown in FIG. 3a. This again also shows the liquid valve and the riser pipe 16 adjoining it. The openings 34 can also be seen here. The reference numeral 54 relates to a tapering section which adjoins the valve 40.

FIGS. 4a and 4b show a further embodiment of a container according to the invention with a container closure. In this embodiment the hollow space 22 is not formed to encircle the container mouth, but only in a section which adjoins the opening 34. Thus the opening 34 is aligned here in the said hollow space 22, so that a gas exchange is possible via the valve 20.

As can also be seen in particular in FIG. 4b, the container closure 1 here has an annular disc 58 in order to dispose the container closure on the carrying ring 36, for example by glueing or welding.

Finally, FIG. 5 shows a representation of a container 10 according to the invention. In addition to the opening 32 which is usually present, the openings 34 are also provided in the circumferential wall of the container and so is the carrying ring 36 which is disposed below these openings 34 and which here, as mentioned above, can also serve in particular for securing or fastening or sealing of the closure 1. The reference numeral 10b relates to a main body of the container which serves here in particular to receive liquids.

The applicant reserves the right to claim all the features disclosed in the application documents as essential to the invention in so far as they are individually or in combination novel over the prior art.

### LIST OF REFERENCE SKINS

1 container closure
2 receiving region
4 first opening
6 fastening means
8 covering means
10 container
10a mouth section
10b main body
10d external thread
12 predetermined opening section
16 pipe section
20 second valve device
22 hollow space
30 circumferential wall
30a mouth rim
32 mouth
34 second openings
36 annular section/carrying ring
40 valve
42 sealing means
44 first sealing means
46 engaging section
52 thread
52a sections
54 tapering section
55 engaging section
58 annular disc
L longitudinal axis
E1 first plane
E2 second plane
A-A illustrated line

1. A container to receive liquids, comprising a main body which surrounds a receiving volume to receive the liquid, and a mouth section for delivery and/or withdrawal of the liquid, wherein this mouth section has a first opening via which the liquid can be withdrawn from the container, characterised in that at least one second opening is provided in the mouth section and by means of said second opening a gaseous medium can be delivered to the container at least intermittently, wherein said first opening is in a first plane and the second opening is in a second plane.

2. The container according to claim 1, wherein the mouth section has a circumferential wall surrounding the first opening and the second opening is disposed in the circumferential wall.

3. The container according to claim 1, wherein a plurality of second openings spaced apart from one another are provided in the mouth section.

4. The container according to claim 1, wherein the first plane and the second plane are substantially perpendicular to one another.

5. The container according to claim 1, wherein the first opening and the second opening are spaced apart from one another.

6. The container according to claim 1, wherein an encircling ring extending at least also in a radial direction of the container is disposed on the mouth section.

7. The container according to claim 1, wherein at least one second opening has a circular or a slot-shaped cross-section.

8. The container according to claim 6, wherein the at least one second opening is disposed above the encircling ring.

9. A method for producing a container to receive liquids, comprising a main body which surrounds a receiving volume to receive the liquid, and a mouth section for delivery and/or withdrawal of the liquid, wherein this mouth section has a first opening via which the liquid can be withdrawn from the container, characterised in that at least one second opening is provided in the mouth section and by means of said second opening a gaseous medium can be delivered to the container at least intermittently, wherein said first opening is in a first plane and the second opening is in a second plane,
wherein a plastic parison is provided which is then transformed by a blow molding process to produce a plastic container, characterised in that at least one second opening is formed during or after the production of the plastic parison.

10. The method as claimed in claim 8, wherein at least one second opening is produced after the transformation by the blow molding process.

11. The container according to claim 8, wherein at least one second opening is produced by a mechanical operation.
